(19) United States
(12) Patent Application Publication
(10) Pub. No.: US 2004/0150144 A1
(43) Pub. Date: Aug. 5, 2004

(54) Elastomeric vibration and shock isolation for inertial sensor assemblies

(75) Inventors: Scott J. Goepfert, White Bear Lake, MN (US); Todd L. Braman, Columbia Heights, MN (US); Dale J. Hagenson, Wyoming, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/354,536

(22) Filed: Jan. 30, 2003

(51) Int. Cl. F16M 11/00

(52) U.S. Cl. 267/136

(57) ABSTRACT

An inertial sensor system has a base, an inertial sensor, and an isolator mount. The isolator mount fastens the inertial sensor to the base, and the isolator mount includes a bolt and first and second vibration absorbing members. The bolt is inserted through the inertial sensor and the base, the first vibration absorbing member is between the bolt and the inertial sensor, and the second vibration absorbing member is between the inertial sensor and the base. The isolator mount isolates the inertial sensor from vibration, shock, and/or acoustic noise transmitted from a host system through the base.

### TECHNICAL FIELD OF THE INVENTION

The present invention relates to isolation mounting systems for limiting the transmission of externally generated vibrational, shock, and/or acoustic energy to mechanically sensitive components such as inertial sensors.

### BACKGROUND OF THE INVENTION

Inertia sensors, such as gyroscopes and/or accelerometers, are commonly used in inertial guidance systems for flight control and/or navigational applications. For example, inertial sensors are used to measure the rotation and/or linear acceleration necessary for computing the velocity and heading of a host system.

The inertial sensors provide inertial data to a navigational computer on board the host system. The navigational computer processes the data for flight control and/or navigation of the host system. For optimum performance, the inertial sensors must provide precise inertial data to the navigational computer. Maneuvers (such as acceleration, takeoff, landing, and changes in roll, pitch, and yaw), turbulence, and engine operation all generate shock, vibration, and acoustic energy that are conveyed through the frame of the host system to the support of the inertial sensors. This energy may manifest itself as linear or angular errors in the inertial data provided by the inertial sensors to the navigational computer.

In general, inertial sensors are particularly sensitive to the vibration, shock, and/or acoustic inputs that are often transmitted to them from their host systems. These inputs frequently cause errors in the outputs of the inertial sensors, which ultimately result in velocity and heading errors for the host systems.

Therefore, it is desirable to isolate inertial sensors from vibration, shock, and/or acoustic inputs so that their nominal outputs accurately report the linear and/or rotational motion of the host systems.

Typically, each host system includes three inertial sensors that are orthogonally mounted to an inertial measurement unit (IMU). Each inertial sensor may comprise an accelerometer, a rotation sensor, or both an accelerometer and a rotation sensor. Each rotation sensor senses rotation about a corresponding one of the x, y, and z axes, and each accelerometer senses acceleration along a corresponding one of the x, y, and z axes. The inertial sensors, along with related electronics and hardware, are generally rigidly and precisely mounted to a housing of an inertial measurement unit. Commonly, the housing is in turn mounted to a support or chassis through suspension mounts or vibration isolators. In turn, the chassis is rigidly and precisely mounted to a frame of a host system, such as an aircraft. These mounting systems are intended to isolate the inertial sensors from the vibration, shock, and acoustic noise energy generated by the host systems.

One known vibration isolator system includes inertial sensors that are fixedly mounted to a housing having a cover member fastened to a base member. The base member in turn is fastened to an inertia ring. Three isolator mounts are fastened between the inertial ring and the frame of the host system through three corresponding elastomeric elements that provide the isolator mounts with shock and vibration isolation functionality. Each elastomeric element is injection molded onto an outer frame of a corresponding isolator mount and is a donut-shaped member having an inner aperture that receives a threaded fastener. These threaded fasteners engage the inertia ring to fasten the elastomeric elements to the inertia ring, and the outer frames of the isolator mounts are fastened to the host system.

Another known vibration isolation system is disclosed in U.S. Pat. No. 5,890,569 to Goepfert. This vibration isolator system includes an isolator mount defined by an annular elastomeric member, a rigid annular outer member, and a rigid annular inner member. The rigid outer member encircles the outside perimeter of and is concentric with the elastomeric member. The rigid inner member is encircled by the inside perimeter of and is concentric with the elastomeric member. The inner member is fastened to the housing that supports the inertial sensors, and the outer member is fastened to the frame of the host system. The elastomeric member isolates the inertial sensors from shock and vibration that may otherwise be transmitted to the inertial sensors from the frame of the host system.

Yet another known vibration isolation system is disclosed in U.S. patent application Ser. No. 09/842,586 filed on Apr. 26, 2001. This vibration isolator system includes an isolator mount having a ring shaped elastomeric member, a rigid ring shaped outer member, and a rigid ring shaped inner member. The outer member encircles an outer perimeter of and is concentric with the ring shaped elastomeric member. The inner member is encircled by the inner perimeter of and is concentric with the elastomeric member. The inner member is fastened to a housing of an inertial measurement unit (IMU) that supports the inertial sensors, and the outer member rests on a ledge of a base member that is fastened to the frame of the host system.

These isolation systems function well to isolate the inertial sensors from the vibration, shock, and acoustic noise of the host system. However, these isolation systems are complex and expensive. The present invention is directed to an isolation system that solves one or more these or other problems.

### SUMMARY OF THE INVENTION

In accordance with one aspect of the present invention, an inertial sensor system comprises a base, an inertial sensor, and an isolator mount. The isolator mount fastens the inertial sensor to the base, and the isolator mount comprises a bolt and first and second vibration absorbing members. The bolt is inserted through the inertial sensor and the base, the first vibration absorbing member is between the bolt and the inertial sensor, and the second vibration absorbing member is between the inertial sensor and the base.

In accordance with another aspect of the present invention, a method of fastening an inertial sensor to a host so that the inertial sensor is isolated from host vibration, shock, and/or acoustic noise comprises the following: inserting a fastening member through a first elastomeric ring; inserting the fastening member through the inertial sensor so that the first elastomeric ring is between the fastening member and the inertial sensor; inserting the fastening member through a second elastomeric ring so that the inertial sensor is between the first and second elastomeric rings; and, fastening the fastening member to the host so that the second elastomeric ring is between the inertial sensor and the host.

In accordance with yet another aspect of the present invention, an inertial sensor system comprises an inertial sensor and first, second, and third isolator mounts. The first isolator mount fastens the inertial sensor to a host, and the first isolator mount comprises a first fastening member and first and second vibration absorbing members. The first fastening member is inserted through the inertial sensor and the host, the first vibration absorbing member is between the first fastening member and the inertial sensor, and the second vibration absorbing member is between the inertial sensor and the host. The second isolator mount fastens the inertial sensor to the host, and the second isolator mount comprises a second fastening member and third and fourth vibration absorbing members. The second fastening member is inserted through the inertial sensor and the host, the third vibration absorbing member is between the second fastening member and the inertial sensor, and the fourth vibration absorbing member is between the inertial sensor and the host. The third isolator mount fastens the inertial sensor to the host, and the third isolator mount comprises a third fastening member and fifth and sixth vibration absorbing members. The third fastening member is inserted through the inertial sensor and the host, the fifth vibration absorbing member is between the third fastening member and the inertial sensor, and the sixth vibration absorbing member is between the inertial sensor and the host.

In accordance with still another aspect of the present invention, an inertial sensor system comprises first, second, and third inertial sensors, and first, second, and third isolator mounts. The first isolator mount fastens the first inertial sensor to a host, and the first isolator mount comprises a first bolt and first and second vibration absorbing members. The first bolt is inserted through the first and second vibration absorbing members, the first inertial sensor, and the host, the first vibration absorbing member is between the first bolt and the first inertial sensor, and the second vibration absorbing member is between the first inertial sensor and the host. The second isolator mount fastens the second inertial sensor to the host, and the second isolator mount comprises a second bolt and third and fourth vibration absorbing members. The second bolt is inserted through the third and fourth vibration absorbing members, the second inertial sensor, and the host, the third vibration absorbing member is between the second bolt and the second inertial sensor, and the fourth vibration absorbing member is between the second inertial sensor and the host. The third isolator mount fastens the third inertial sensor to the host, and the third isolator mount comprises a third bolt and fifth and sixth vibration absorbing members. The third bolt is inserted through the fifth and sixth vibration absorbing members, the third inertial sensor, and the host, the fifth vibration absorbing member is between the third bolt and the third inertial sensor, and the sixth vibration absorbing member is between the third inertial sensor and the host.

### BRIEF DESCRIPTION OF THE DRAWINGS

These and other features and advantages will become more apparent from a detailed consideration of the invention when taken in conjunction with the drawings in which:

FIG. 1 is an exploded view of a vibration isolator system for mounting an inertial sensor to a base of an inertial measurement unit;

FIG. 2 is a cross sectional side view of the vibration isolator system that mounts the inertial sensor to the base of the inertial measurement unit of FIG. 1;

FIG. 3 is an enlarged view of a portion of the vibration isolator system shown in FIG. 2; and,

FIG. 4 is another exploded view of the vibration isolator system shown in FIGS. 1, 2, and 3.

### DETAILED DESCRIPTION

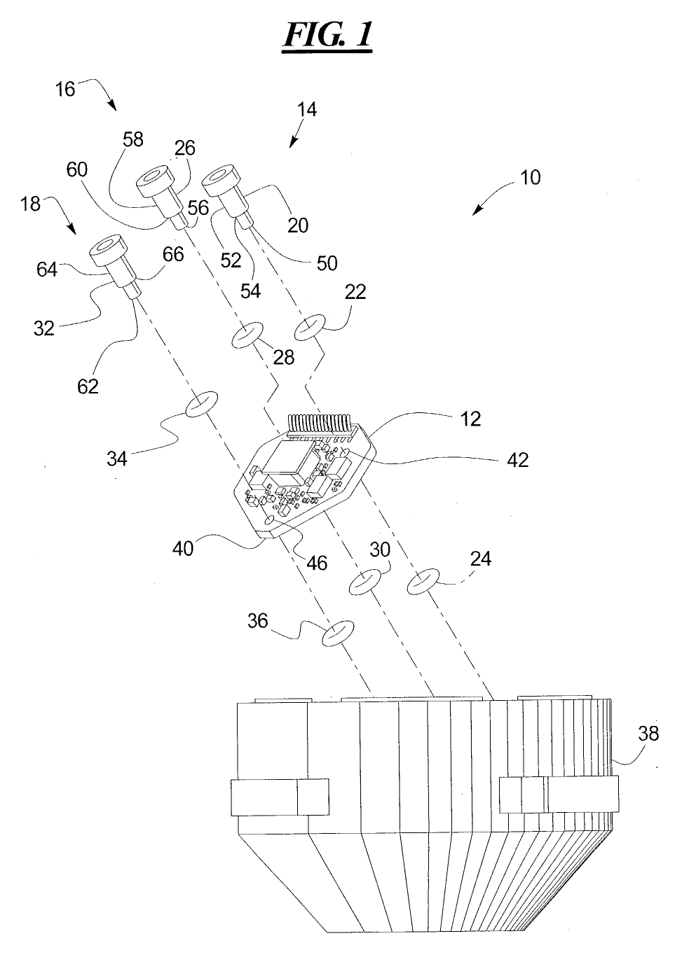

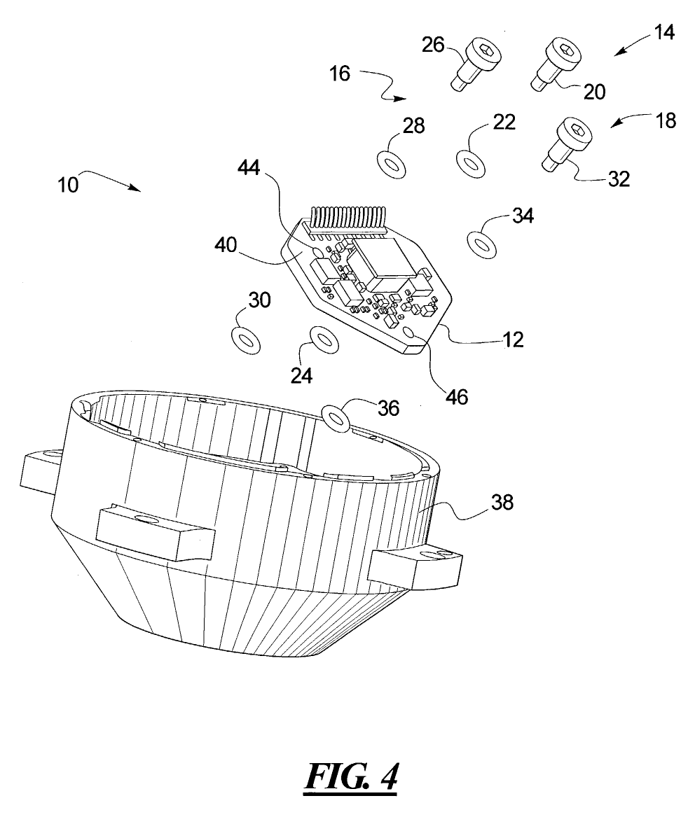

As shown in FIGS. 1-4, a vibration isolation system 10 for an inertial sensor assembly 12 includes isolator mounts 14, 16, and 18. The isolator mount 14 is defined by a shoulder bolt 20 and by vibration absorbing members 22 and 24, the isolator mount 16 is defined by a shoulder bolt 26 and by vibration absorbing members 28 and 30, and the isolator mount 18 is defined by a shoulder bolt 32 and by vibration absorbing members 34 and 36. The isolator mounts 14, 16, and 18 fasten the inertial sensor assembly 12 to a base 38 of an inertial measurement unit so as to isolate the inertial sensor assembly 12 from the vibrations of a host system to which the base 38 is fastened.

Each of the vibration absorbing members 22, 24, 28, 30, 34, and 36 may be a corresponding elastomeric member such as an elastomeric ring or elastomeric O-ring. The inertial sensor assembly 12 may comprise a board 40, such as a printed circuit board, to which are mounted one or more inertial sensors. For example, an accelerometer, a rotation sensor such as a ring laser gyroscope, or a combination of an accelerometer and a rotation sensor may be mounted to the board 40. In addition, one or more electronic components association with the one or more inertial sensors may also be mounted to the board 40.

The board 40 has holes 42, 44, and 46 therethrough that cooperate with the shoulder bolts 20, 26, and 32. Accordingly, when the inertial sensor assembly 12 is fastened to the base 38, the shoulder bolt 20 is inserted through the vibration absorbing member 22, then through the hole 42 in the board 40, and then through the vibration absorbing member 24. Finally, the shoulder bolt 20 is fastened to the base 38. For example, the shoulder bolt 20 may be threaded into the base 38. Similarly, the shoulder bolt 26 is inserted through the vibration absorbing member 28, then through the hole 44 in the board 40, and then through the vibration absorbing member 30. The shoulder bolt 26 is then fastened to the base 38. For example, the shoulder bolt 26 may be threaded into the base 38. Likewise, the shoulder bolt 32 is inserted through the vibration absorbing member 34, then through the hole 46 in the board 40, and then through the vibration absorbing member 36. The shoulder bolt 32 is then fastened to the base 38. For example, the shoulder bolt 32 may be threaded into the base 38. The hole 46 must be big enough to provide adequate sway space between the hole and the shoulder bolt 32 during shock and vibration inputs.

Accordingly, when the inertial sensor assembly 12 is fastened to the base 38, the vibration absorbing member 22 is between the shoulder bolt 20 and the board 40, the board 40 is between the vibration absorbing member 22 and the vibration absorbing member 24, and the vibration absorbing member 24 is between the board 40 and the base 38. Similarly, the vibration absorbing member 28 is between the shoulder bolt 26 and the board 40, the board 40 is between the vibration absorbing member 28 and the vibration absorbing member 30, and the vibration absorbing member 30 is between the board 40 and the base 38. Likewise, the vibration absorbing member 34 is between the shoulder bolt 32 and the board 40, the board 40 is between the vibration absorbing member 34 and the vibration absorbing member 36, and the vibration absorbing member 36 is between the board 40 and the base 38.

As indicated above, each of the vibration absorbing members 22, 24, 28, 30, 34, and 36 may be a corresponding elastomeric member such as an elastomeric ring or an elastomeric O-ring. In these cases, the elastomeric material may be phenyl-methyl vinyl silicone rubber of the form 2FC303A19B37E016F1-11G11 as specified in the American Society for Testing and Materials (ASTM) document ASTM-D2000. Materials of this type are fabricated by numerous manufacturers for a variety of applications.

Each of the isolator mounts 14, 16, and 18 as described above is an elegant approach for providing the necessary vibration, shock, and/or acoustic noise attenuation needed for inertial sensors to be accurately employed in flight control and/or navigation systems. Each of the isolator mounts 14, 16, and 18 is uniquely simple, inexpensive, and effective in providing vibration, acoustic, and/or shock isolation for inertial sensors.

The isolator mounts 14, 16, and 18 are also flexible. For example, the clamping force of the shoulder bolts 20, 26, and 32 and the properties of the vibration absorbing members 22, 24, 28, 30, 34, and 36 may be varied to provide a multitude of different damping characteristics. Therefore, the frequency response of the isolator mounts 14, 16, and 18 may be selected for numerous system applications that have widely different vibration, shock, and/or acoustic noise environments.

The shoulder bolt 20 has first and second portions 50 and 52 separated by a shoulder 54. The first portion 50 is threaded, and the second portion 52 may be threaded or non-threaded, although the second portion 52 is preferably non-threaded. The length of the second portion 52 can be selected to precisely control the compression on the vibration absorbing members 22 and 24 when the shoulder bolt 20 is threaded into the base 38. Similarly, the shoulder bolt 26 has first and second portions 56 and 58 separated by a shoulder 60. The first portion 56 is threaded, and the second portion 58 may be threaded or non-threaded, although the second portion 58 is preferably non-threaded. The length of the second portion 58 can be selected to precisely control the compression on the vibration absorbing members 28 and 30 when the shoulder bolt 26 is threaded into the base 38. Likewise, the shoulder bolt 32 has first and second portions 62 and 64 separated by a shoulder 66. The first portion 62 is threaded, and the second portion 64 may be threaded or non-threaded, although the second portion 64 is preferably non-threaded. The length of the second portion 64 can be selected to precisely control the compression on the vibration absorbing members 34 and 36 when the shoulder bolt 32 is threaded into the base 38.

By controlling the compression on the vibration absorbing members 22, 24, 28, 30, 34, and 36, the frequency responses, damping, sway space, and/or axial-to-radial performance of the isolator mounts 14, 16, and 18 may be selected for numerous system applications. For example, increasing the length of the second portions 52, 58, and 64 results in a decrease in the clamping forces on the vibration absorbing members 22, 24, 28, 30, 34, and 36. In turn, the natural frequency of the isolator mounts 14, 16, and 18 decreases, and the damping provided by the isolator mounts 14, 16, and 18 increases for a given material and geometry of the vibration absorbing members 22, 24, 28, 30, 34, and 36. Moreover, as indicated above, the material and geometry of the vibration absorbing members 22, 24, 28, 30, 34, and 36 also may be varied to provide a wide range of response characteristics provided by the isolator mounts 14, 16, and 18.

Furthermore, typical vibration and shock isolators comprise two or more metal structures that are bonded together with elastomeric materials to form an isolator mount. These mounts are intrinsically more expensive to manufacture than is the isolator mount of the present invention.

The isolator mount of the present invention not only enhances the performance of the inertial sensor, the isolator mount also extends the life of the electronics supported with the sensors.

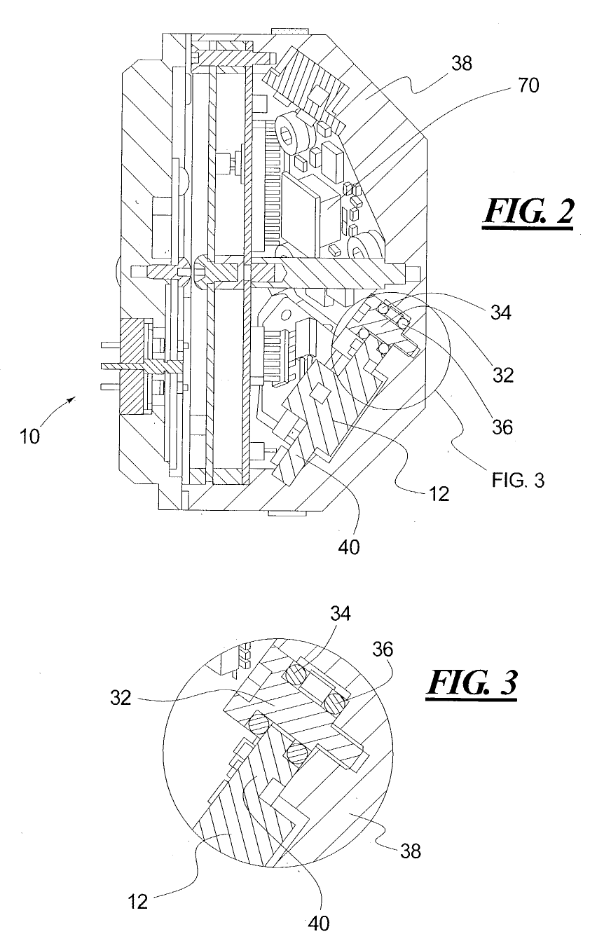

Additional inertial sensors may be fastened to the base 38 using the isolator mounts of the present invention. For example, as shown in FIG. 2, an inertial sensor 70 may be fastened to the base 38 for sensing along and/or about a second axis. Although not shown, a third inertial sensor may be fastened to the base 38 for sensing along and/or about a third axis.

Certain modifications of the present invention have been discussed above. Other modifications will occur to those practicing in the art of the present invention. For example, the three isolator mounts 14, 16, and 18 are used to fasten the inertial sensor assembly 12 to the base 38. However, other numbers of isolation mounts, such as one, two, four, or more may be used to fasten the inertial sensor assembly 12 to the base 38.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. An inertial sensor system comprising:
a base;
an inertial sensor; and,
an isolator mount that fastens the inertial sensor to the base, wherein the isolator mount comprises a bolt and first and second vibration absorbing members, wherein the bolt is inserted through the inertial sensor and the base, wherein the first vibration absorbing member is between the bolt and the inertial sensor, and wherein the second vibration absorbing member is between the inertial sensor and the base.

2. The inertial sensor system of claim 1 wherein the first and second vibration absorbing members comprise corresponding first and second elastomeric rings.

3. The inertial sensor system of claim 1 wherein the first and second vibration absorbing members comprise corresponding first and second elastomeric O-rings.

4. The inertial sensor system of claim 1 wherein the bolt comprises a threaded portion and a non-threaded portion separated by a shoulder.

5. The inertial sensor system of claim 4 wherein the first and second vibration absorbing members comprise corresponding first and second elastomeric rings.

6. The inertial sensor system of claim 5 wherein the first and second vibration elastomeric rings comprise materials selected to produce a predetermined frequency response.

7. The inertial sensor system of claim 4 wherein the first and second vibration absorbing members comprise corresponding first and second elastomeric O-rings.

8. The inertial sensor system of claim 4 wherein the non-threaded portion has a length selected to produce a predetermined frequency response.

9. The inertial sensor system of claim 4 wherein the first and second vibration absorbing members comprise materials selected to produce a predetermined frequency response.

10. The inertial sensor system of claim 9 wherein the non-threaded portion has a length selected to produce the predetermined frequency response.

11. The inertial sensor system of claim 1 wherein the bolt comprises first and second portions separated by a shoulder, wherein the first portion is threaded, and wherein the second portion has a length selected to produce a predetermined frequency response.

12. The inertial sensor system of claim 1 wherein the first and second vibration absorbing members comprise a material selected to produce a predetermined frequency response.

13. The inertial sensor system of claim 12 wherein the bolt comprises first and second portions separated by a shoulder, wherein the first portion is threaded, and wherein the second portion has a length selected to produce the predetermined frequency response.

14. A method of fastening an inertial sensor to a host so that the inertial sensor is isolated from host vibration, shock, and/or acoustic noise comprising:
inserting a fastening member through a first elastomeric ring;
inserting the fastening member through the inertial sensor so that the first elastomeric ring is between the fastening member and the inertial sensor;
inserting the fastening member through a second elastomeric ring so that the inertial sensor is between the first and second elastomeric rings; and,
fastening the fastening member to the host so that the second elastomeric ring is between the inertial sensor and the host.

15. The method of claim 14 wherein the first and second elastomeric rings comprise corresponding first and second elastomeric O-rings.

16. The method of claim 14 wherein the first and second elastomeric rings comprise elastomeric materials selected to produce a predetermined frequency response.

17. The method of claim 14 wherein the fastening member comprises a shoulder bolt.

18. The method of claim 17 wherein the shoulder bolt comprises a portion having a length selected to produce a predetermined frequency response.

19. The method of claim 18 wherein the first and second elastomeric rings comprise elastomeric materials selected to produce the predetermined frequency response.

20. An inertial sensor system comprising:
an inertial sensor;
a first isolator mount fastening the inertial sensor to a host, wherein the first isolator mount comprises a first fastening member and first and second vibration absorbing members, wherein the first fastening member is inserted through the inertial sensor and the host, wherein the first vibration absorbing member is between the first fastening member and the inertial sensor, and wherein the second vibration absorbing member is between the inertial sensor and the host;
a second isolator mount fastening the inertial sensor to the host, wherein the second isolator mount comprises a second fastening member and third and fourth vibration absorbing members, wherein the second fastening member is inserted through the inertial sensor and the host, wherein the third vibration absorbing member is between the second fastening member and the inertial sensor, and wherein the fourth vibration absorbing member is between the inertial sensor and the host; and,
a third isolator mount fastening the inertial sensor to the host, wherein the third isolator mount comprises a third fastening member and fifth and sixth vibration absorbing members, wherein the third fastening member is inserted through the inertial sensor and the host, wherein the fifth vibration absorbing member is between the third fastening member and the inertial sensor, and wherein the sixth vibration absorbing member is between the inertial sensor and the host.

21. The inertial sensor system of claim 20 wherein the first, second, third, fourth, fifth, and sixth vibration absorbing members comprise corresponding first, second, third, fourth, fifth, and sixth elastomeric rings.

22. The inertial sensor system of claim 20 wherein each of the first, second, and third fastening members comprises a threaded portion and a non-threaded portion separated by a shoulder.

23. The inertial sensor system of claim 22 wherein the first, second, third, fourth, fifth, and sixth vibration absorbing members comprise corresponding first, second, third, fourth, fifth, and sixth elastomeric rings.

24. The inertial sensor system of claim 23 wherein each of the first, second, third, fourth, fifth, and sixth elastomeric rings comprises a material selected to produce a predetermined frequency response.

25. The inertial sensor system of claim 23 wherein each of the non-threaded portions has a length selected to produce a corresponding predetermined frequency response.

26. The inertial sensor system of claim 25 wherein each of the first, second, third, fourth, fifth, and sixth elastomeric rings comprises a material selected to produce the predetermined frequency responses.

27. The inertial sensor system of claim 20 wherein each of the first, second, and third fastening members has a portion selected to produce a corresponding predetermined frequency response.

28. The inertial sensor system of claim 20 wherein each of the first, second, third, fourth, fifth, and sixth vibration absorbing members comprises a material selected to produce corresponding predetermined frequency responses.

29. The inertial sensor system of claim 28 wherein each of the first, second, and third fastening members has a portion selected to produce the predetermined frequency responses.

30. An inertial sensor system comprising:
first, second, and third inertial sensors;
a first isolator mount fastening the first inertial sensor to a host, wherein the first isolator mount comprises a first bolt and first and second vibration absorbing members, wherein the first bolt is inserted through the first and second vibration absorbing members, the first inertial sensor, and the host, wherein the first vibration absorbing member is between the first bolt and the first inertial sensor, and wherein the second vibration absorbing member is between the first inertial sensor and the host;
a second isolator mount fastening the second inertial sensor to the host, wherein the second isolator mount comprises a second bolt and third and fourth vibration absorbing members, wherein the second bolt is inserted through the third and fourth vibration absorbing members, the second inertial sensor, and the host, wherein the third vibration absorbing member is between the second bolt and the second inertial sensor, and wherein the fourth vibration absorbing member is between the second inertial sensor and the host; and,
a third isolator mount fastening the third inertial sensor to the host, wherein the third isolator mount comprises a third bolt and fifth and sixth vibration absorbing members, wherein the third bolt is inserted through the fifth and sixth vibration absorbing members, the third inertial sensor, and the host, wherein the fifth vibration absorbing member is between the third bolt and the third inertial sensor, and wherein the sixth vibration absorbing member is between the third inertial sensor and the host.

31. The inertial sensor system of claim 30 wherein the first, second, third, fourth, fifth, and sixth vibration absorbing members comprise corresponding first, second, third, fourth, fifth, and sixth elastomeric rings.

32. The inertial sensor system of claim 30 wherein each of the first, second, and third fastening members comprises a threaded portion and a non-threaded portion separated by a shoulder.

33. The inertial sensor system of claim 32 wherein the first, second, third, fourth, fifth, and sixth vibration absorbing members comprise corresponding first, second, third, fourth, fifth, and sixth elastomeric rings.

34. The inertial sensor system of claim 33 wherein each of the first, second, third, fourth, fifth, and sixth elastomeric rings comprises a material selected to produce a predetermined frequency response.

35. The inertial sensor system of claim 33 wherein each of the non-threaded portions has a length selected to produce a corresponding predetermined frequency response.

36. The inertial sensor system of claim 35 wherein each of the first, second, third, fourth, fifth, and sixth elastomeric rings comprises a material selected to produce the predetermined frequency responses.

37. The inertial sensor system of claim 30 wherein each of the first, second, and third fastening members has a portion selected to produce a corresponding predetermined frequency response.

38. The inertial sensor system of claim 30 wherein each of the first, second, third, fourth, fifth, and sixth vibration absorbing members comprises a material selected to produce a corresponding predetermined frequency response.

39. The inertial sensor system of claim 38 wherein each of the first, second, and third fastening members has a portion selected to produce the predetermined frequency responses.
